(19) United States
(12) Patent Application Publication
(10) Pub. No.: US 2018/0020203 A1
(43) Pub. Date: Jan. 18, 2018

(54) INFORMATION PROCESSING APPARATUS, METHOD FOR PANORAMIC IMAGE DISPLAY, AND NON-TRANSITORY COMPUTER-READABLE STORAGE MEDIUM

(71) Applicant: FUJITSU LIMITED, Kawasaki-shi (JP)

(72) Inventors: Katsushi Miura, Atsugi (JP); Shan Jiang, Zama (JP); Sosuke Yamao, Atsugi (JP); Keiju Okabayashi, Sagamihara (JP)

(73) Assignee: FUJITSU LIMITED, Kawasaki-shi (JP)

(21) Appl. No.: 15/617,467

(22) Filed: Jun. 8, 2017

(30) Foreign Application Priority Data
Jul. 15, 2016 (JP) 2016-140811

(51) Int. Cl. H04N 13/00; H04N 5/232; G06K 9/46; H04N 13/04

(52) U.S. Cl. CPC H04N 13/0014; H04N 13/0497; H04N 5/23293; G06T 7/74; G06K 9/46; G06T 2207/30244

(57) ABSTRACT

An information processing apparatus includes: a memory; and a processor coupled to the memory and configured to execute an acquisition process that includes acquiring a plurality of images which are captured from different positions and include a same feature point, execute a specification process that includes specifying the direction of sight of a user who looks at a panoramic image which is generated based on the plurality of images, and execute a display control process that includes selecting particular images from the plural images based on the direction of sight and displaying the panoramic image composed of the selected particular images.

### CROSS-REFERENCE TO RELATED APPLICATION

This application is based upon and claims the benefit of priority of the prior Japanese Patent Application No. 2016-140811, filed on Jul. 15, 2016, the entire contents of which are incorporated herein by reference.

### FIELD

The embodiment discussed herein is related to an information processing apparatus, a method for panoramic image display, and a non-transitory computer-readable storage medium.

### BACKGROUND

Currently, work sites face problems including labor shortages and on-site engineer development. It is therefore difficult in some cases to provide skilled engineers to work sites. To solve such problems, there is a system in which a skilled, remote engineer is able to cooperate with an on-site engineer by seeing information of the remote site and instructing the on-site engineer. The system may use an augmented reality (AR) technique together to overlay virtual world information on a real environment picture taken with a camera, thus increasing the work efficiency.

FIG. 16 is a diagram illustrating an example of conventional systems. In the system illustrated in FIG. 16 as an example, an on-site operator 2 works based on an instruction from an instructor 1. The operator 2 wears an operator terminal 50, a display device 21d, and a camera 21c. The operator terminal 50 is connected to the display device 21d and camera 21c through wireless communication or the like. An image frame 2c including a two-dimensional (2D) image captured by the camera 21c of the operator 2 is transmitted to a remote assisting apparatus 60 of the instructor 1 through a wireless network communication function of the operator terminal 50. The range represented by the image of the image frame 2c is indicated by a viewing field 7d.

The remote assisting apparatus 60 is operated by the instructor 1. The remote assisting apparatus 60 generates a three-dimensional (3D) panoramic image 4 from the image frame 2c transmitted from the operator terminal 50 in the remote location and displays the generated three-dimensional panoramic image 4. The instructor 1 understands the situation of the work site at the remote location based on the three-dimensional panoramic image 4 displayed on the remote assisting apparatus 60. The three-dimensional panoramic image 4 is updated each time that the remote assisting apparatus 60 receives the image frame 2c.

The instructor 1 indicates a certain place on the three-dimensional panoramic image 4 by clicking, for example. The remote assisting apparatus 60 then transmits to the operator terminal 50, information about the position within the image frame 2c at which the instructor 1 has clicked and instruction information 2f including an instruction 2g. Upon receiving the instruction information 2f, the operator terminal 50 displays the instruction 2g on the display device 21d. The operator 2 works with reference to the instruction 2g displayed on the display device 21d.

Herein, a description is given of an example of a conventional processing to generate the three-dimensional panoramic image 4. The conventional technique calculates position and orientation information of the camera 21c at the time the camera 21c captures the image frame 2c, based on simultaneous localization and mapping (SLAM) or the like. The conventional technique uses the position and orientation information of the camera 21c and internal parameters of the camera 21c acquired in advance to generate a three-dimensional image draw object of a frustum shape and perform texture mapping for the bottom of the three-dimensional image draw object with the image frame 2c. The conventional technique disposes the texture-mapped three-dimensional image draw object in a three-dimensional space based on the position and orientation information of the camera 21c. The conventional technique repeatedly executes the aforementioned process to generate the three-dimensional panoramic image 4. Examples of the related art include Japanese Laid-open Patent Publications Nos. 2012-53896 and 2002-209208.

### SUMMARY

According to an aspect of the invention, an information processing apparatus includes: a memory; and a processor coupled to the memory and configured to execute an acquisition process that includes acquiring a plurality of images which are captured from different positions and include a same feature point, execute a specification process that includes specifying the direction of sight of a user who looks at a panoramic image which is generated based on the plurality of images, and execute a display control process that includes selecting particular images from the plural images based on the direction of sight and displaying the panoramic image composed of the selected particular images.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is an example of three-dimensional panoramic images generated by an image processing apparatus of a referential example;

FIG. 2 is a view for explaining positions where images are captured depending on movement of the operator;

FIG. 3 is a view illustrating an example of three-dimensional panoramic images that are difficult for the user to see;

FIG. 4 is a diagram illustrating the configuration of a system according to an embodiment;

FIG. 5 is a functional block diagram illustrating the configuration of an operator terminal according to the embodiment;

FIG. 6 is a functional block diagram illustrating the configuration of an information processing apparatus according to the embodiment;

FIG. 7 is a diagram illustrating an example of the data structure of a management table;

FIG. 8 is a diagram illustrating an example of the data structure of a list;

FIG. 9 is a diagram illustrating an example of the data structure of a panoramic image table;

FIG. 10 is a diagram for explaining a process to calculate a viewing angle;

FIG. 11 is a diagram No. 1 for explaining a process by a display controller;

FIG. 12 is a diagram No. 2 for explaining the process by the display controller;

FIG. 13 is a flowchart illustrating an example of the processing procedure of a system according to the embodiment;

FIG. 14 is a flowchart illustrating the processing procedure of a three-dimensional panoramic image generating process;

FIG. 15 is a diagram illustrating an example of the hardware configuration of a computer implementing the same function as that of the information processing apparatus; and

FIG. 16 is a diagram illustrating an example conventional system.

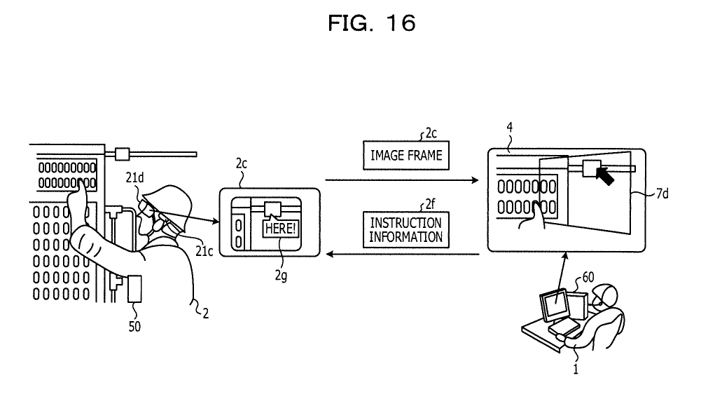

### DESCRIPTION OF EMBODIMENT

The aforementioned conventional technique has a difficulty in generating a panoramic image that is easily visible in the user's line of sight.

According to an aspect, an object of the present disclosure is to provide an information processing apparatus, a panoramic image display method, and a panoramic image display program which are capable of generating a panoramic image that is easily visible in the user's line of sight.

Hereinafter, a description is given of embodiments of an information processing apparatus, a panoramic image display method, and a panoramic image display program disclosed in the application based on the drawings in detail. The embodiments do not limit the present disclosure.

### Embodiment

A description is given of a referential example of generation of a three-dimensional panoramic image prior to description of the information processing apparatus according to the embodiment. The referential example described below is not a conventional art. The image processing apparatus described as the referential example extracts feature points from image data recorded by a camera and calculates the distances between the feature points and image capture positions where the camera records the image data. The image processing apparatus generates three-dimensional image draw objects subjected to texture mapping with the image data and disposes the 3 three-dimensional image draw objects in accordance with the calculated distances between the feature points and image capture positions, generating a three-dimensional panoramic image.

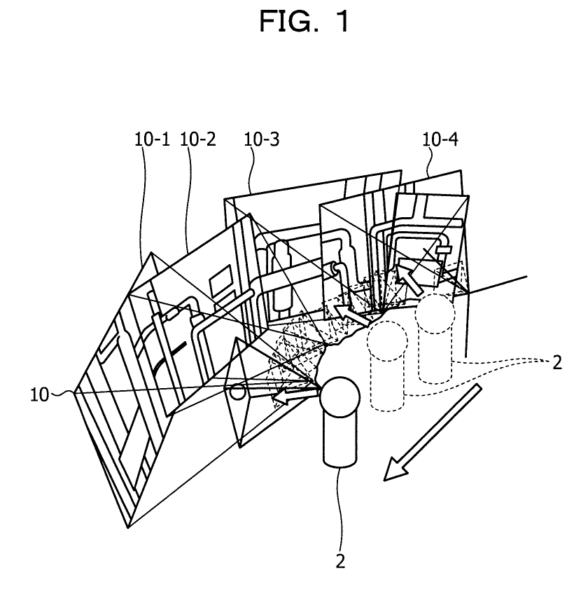

FIG. 1 is a diagram illustrating an example of three-dimensional panoramic images generated by the image processing apparatus of the referential example. In the example illustrated in FIG. 1, three-dimensional draw objects 10-1, 10-2, 10-3, and 10-4 are disposed in accordance with the distances between the image capture positions and feature points to generate a three-dimensional panoramic image 10. The image processing apparatus of the referential example expects that an on-site operator 2 performs movement like looking around the site without changing position much. If the operator 2 moves as expected, the image processing apparatus is able to generate the three-dimensional panoramic image properly.

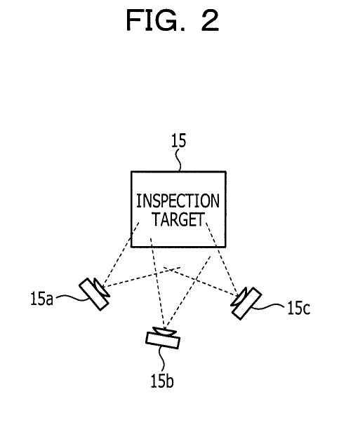

However, operators do not move as expected in some cases. On the inspection site, for example, the operator 2 checks a particular object by looking at the object from various directions in some cases, such as at inspection for corrosion and cracks in tube joints. FIG. 2 is a diagram for explaining the image capture positions depending on the operator's location. In the example illustrated in FIG. 2, the operator 2 inspects a target 15 at image capturing positions 15a, 15b, 15c, and other positions.

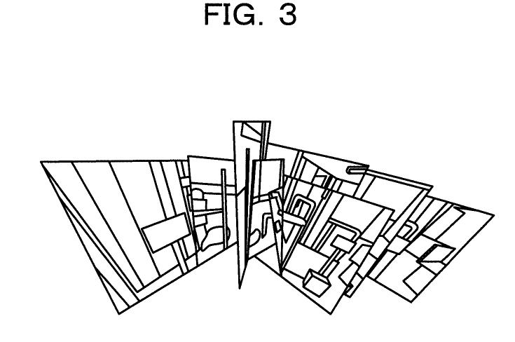

When the operator 2 performs inspection as illustrated in FIG. 2, a three-dimensional panoramic image illustrated in FIG. 3 is generated, for example. FIG. 3 is a diagram illustrating an example of three-dimensional panoramic images that the user would have difficulty in seeing. When the operator 2 performs inspection as illustrated in FIG. 2, three-dimensional draw objects including corresponding feature points are displayed so as to cross each other. Accordingly, the generated three-dimensional panoramic image would be very difficult for the user to see.

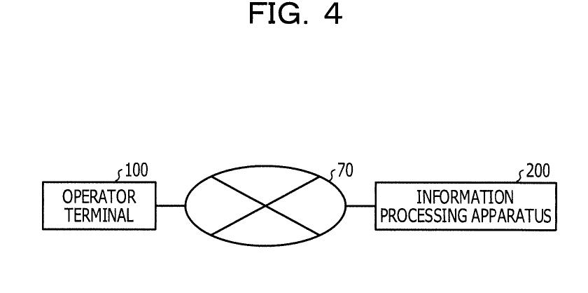

Next, a description is given of the configuration of a system according to the embodiment. FIG. 4 is a diagram illustrating the configuration of the system according to the embodiment. As illustrated in FIG. 4, the system includes an operator terminal 100 and an information processing apparatus 200. The operator terminal 100 and information processing apparatus 200 are connected to each other through a network 70.

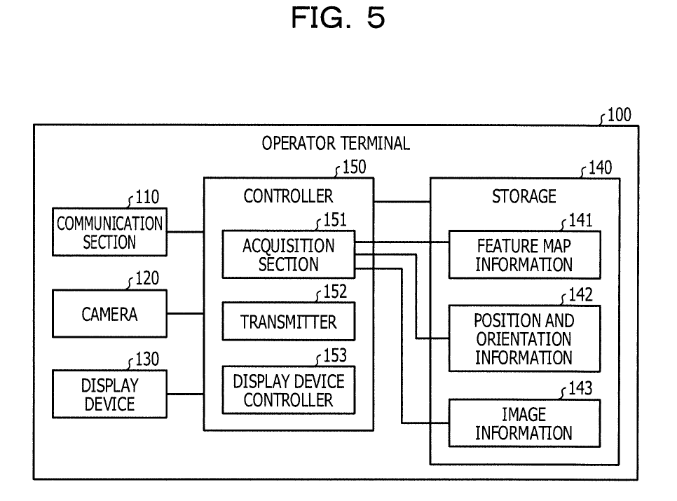

The operator terminal 100 is a terminal device worn by an operator working on site. FIG. 5 is a functional block diagram illustrating the configuration of an operator terminal according to the embodiment. As illustrated in FIG. 5, the operator terminal 100 includes a communication section 110, a camera 120, a display device 130, a storage 140, and a controller 150.

The communication section 110 is a processing section configured to execute data communication with the information processing apparatus 200 through the network 70. The communication section 110 corresponds to a communication device, for example. The later-described controller 150 exchanges information with the information processing apparatus 200 through the communication section 110.

The camera 120 is a camera worn by an operator. The camera 120 is connected to the operator terminal 100 through wireless communication or the like. The camera 120 is a wearable, compact camera composed of a charge coupled device (CCD) or the like, such as a head mounted camera (HMC). The camera 120 captures an image in the field of view and outputs information of the captured image to the operator terminal 100.

The display device 130 is a display device configured to display the information outputted from the controller 150. The display device 130 is a wearable display device capable of receiving and outputting audio, such as a head mounted display (HMD), for example. The display device 130 displays instruction information by an instructor which is transmitted from the information processing apparatus 200, for example.

The storage 140 includes feature map information 141, position and orientation information 142, and image information 143. The storage 140 corresponds to a semiconductor memory device such as a random access memory (RAM), a read only memory (ROM), or a flash memory or a storage device such as a hard disk drive (HDD).

The feature map information 141 is information in which plural feature points included in the image information 143 recorded by the camera 120 are associated with three-dimensional coordinates of the respective feature points.

The position and orientation information 142 is information representing the position and orientation of the camera 120 when the camera 120 records the image information 143.

The image information 143 is information about an image captured by the camera 120.

The controller 150 includes an acquisition section 151, a transmitter 152, and a display device controller 153. The controller 150 corresponds to an integrated device such as an application specific integrated circuit (ASIC) or a field programmable gate array (FPGA). Alternatively, the controller 150 corresponds to an electronic circuit such as a central processing unit (CPU) or a micro-processing unit (MPU), for example.

The acquisition section 151 is a processing section configured to acquire information about subject's feature points included in the image information recorded by the camera 120 and the position and orientation information of the camera 120. The acquisition section 151 registers the information about the subject's feature points in the feature map information 141. The acquisition section 151 stores the position and orientation information of the camera 120 as the position and orientation information 142 in the storage 140. The acquisition section 151 registers the image information recorded by the camera 120, in the storage 140 as the image information 143.

A description is given of an example of a process by the acquisition section 151 to calculate the information about the feature points. The acquisition section 151 acquires image information from the camera 120 and extracts feature points from the image information. The acquisition section 151 extracts feature points from the image information by executing edge detection for the image information, for example.

The acquisition section 151 compares feature points of first image information recorded by the camera 120 at time T1 with feature points of second image information recorded by the camera 120 at time T2 to associate corresponding feature points with each other. For example, the acquisition section 151 compares feature quantities of the extracted feature points to determine the pair of feature points with the smallest difference in feature quantity to be corresponding feature points. The feature quantity corresponds to luminance distribution, edge strength, or the like.

Based on the coordinates of the corresponding feature points included in the first and second image information and the principle of stereo-matching, the acquisition section 151 calculates the three-dimensional coordinates of the feature points. The acquisition section 151 repeatedly executes the aforementioned process for each feature point to calculate the three-dimensional coordinates of the feature point, thus acquiring information of the feature points.

A description is given of an example of the process by the acquisition section 151 to calculate the position and orientation information of the camera 120. The acquisition section 151 estimates the position and orientation information of the camera 120 through a monocular SLAM function. For example, the acquisition section 151 transforms the three-dimensional coordinates of each feature point in the feature map information 141 to 2D coordinates based on a transformation table. The feature point is thereby projected onto the current image information recorded by the camera 120. In the transformation table, the 2D coordinates calculated from the three-dimensional coordinates of features vary depending on the position and orientation information of the camera 120.

The acquisition section 151 searches for the position and orientation information of the camera 120 that minimizes a gap between a feature on the image information and the projected point of the same feature. The acquisition section 151 acquires the position and orientation information that minimizes the gap, as the current position and orientation information of the camera 120.

The transmitter 152 is a processing section configured to transmit to the information processing apparatus 200, an image frame including the feature map information 141, position and orientation information 142, and image information 143, which are stored in the storage 140. Each time that the image information 143 is updated and the position and orientation information 142 is updated based on the updated image information 143, the transmitter 152 transmits an image frame to the information processing apparatus 200, for example. The transmitter 152 may store information about internal parameters of the camera 120 in the image frame.

The display device controller 153 is a processing section configured to, upon receiving the instruction information from the information processing apparatus 200, display the received instruction information on the display device 130.

The information processing apparatus 200 is an apparatus which receives image frames from the operator terminal 100 and generates a three-dimensional panoramic image. An instructor using the information processing apparatus 200 sees the situation on the work site with reference to the three-dimensional panoramic image and the like.

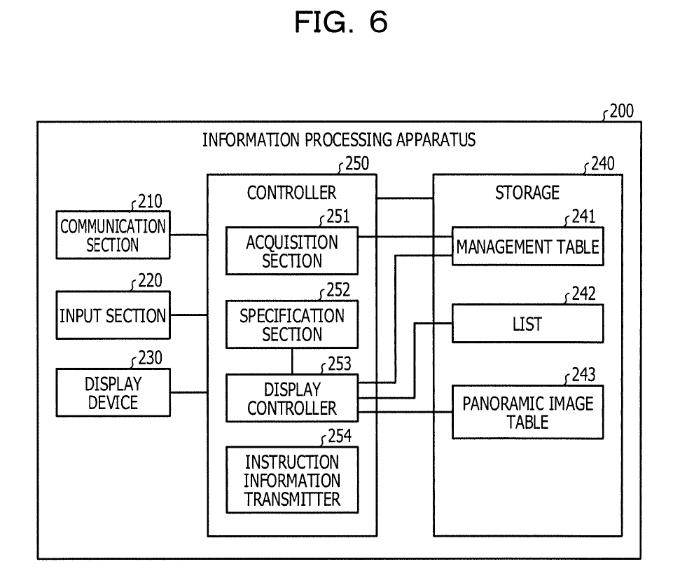

FIG. 6 is a block diagram illustrating the configuration of the information processing apparatus according to the embodiment. As illustrated in FIG. 6, the information processing apparatus 200 includes a communication section 210, an input section 220, a display device 230, a storage 240, and a controller 250.

The communication section 210 is a processing section configured to execute data communication with the operator terminal 100 through the network 70. The communication section 210 corresponds to a communication device, for example. The later-described controller 250 exchanges information with the operator terminal 100 through the communication section 210.

The input section 220 is an input device through which various information is inputted to the information processing apparatus 200. The input section 220 corresponds to a keyboard, a mouse, a touch panel, or the like, for example. The instructor operates the input section 220 to input various types of instruction information. The instructor operates the input section 220 to indicate the instructor's direction of sight when looking at the three-dimensional panoramic image outputted from the controller 250.

The display device 230 is a display device configured to display information outputted from the controller 250. The display device 230 displays information of the three-dimensional panoramic image outputted from the controller 250, for example. The display device 230 corresponds to a liquid crystal display, a touch panel, or the like, for example.

The storage 240 includes a management table 241, a list 242, and a panoramic image table 243. The storage 240 corresponds to a semiconductor memory device such as a RAM, a ROM, or a flash memory or a storage device such as an HDD.

The management table 241 is a table storing image frames transmitted from the operator terminal 100. As described above, each image frame includes the feature map information 141, position and orientation information 142, and image information 143.

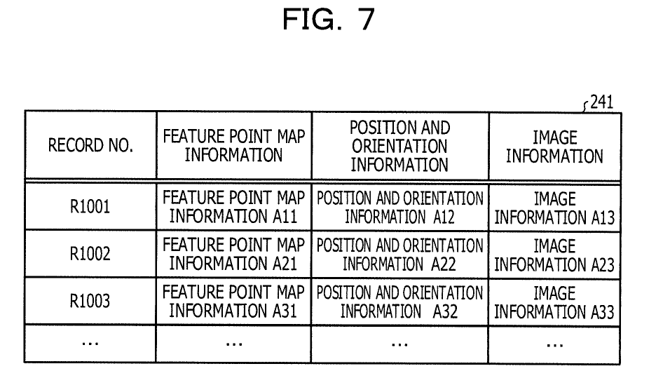

FIG. 7 is a diagram illustrating an example of the data structure of a management table. As illustrated in FIG. 7, the management table 241 stores the feature map information, the position and orientation information, and image information against each record number. The record numbers are information uniquely identifying respective records of the management table 241. The feature map information, position and orientation information, and image information are the same as described above. The feature map information, position and orientation information, and image information included in the same image frame are associated with the same record number to be stored in the management table 241.

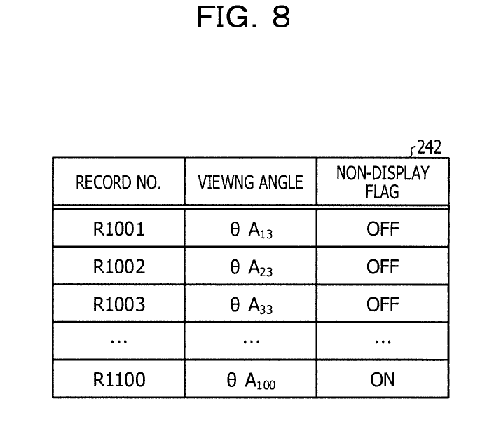

The list 242 is information used to distinguish between image information which will be used in the three-dimensional panoramic image and image information which will not be displayed. FIG. 8 is a diagram illustrating an example of the data structure of a list. As illustrated in FIG. 8, the list 242 includes record numbers, viewing angle, and non-display flags, which are associated with each other. The record numbers are numbers to associate the records in the list 242 with the records in the management table 241. The viewing angle is described later. The non-display flag is information indicating whether the corresponding image information will be displayed. When the non-display flag is off, for example, the image information corresponding to the record number of interest will be displayed. When the non-display flag is on, the image information corresponding to the record number of interest will not be displayed.

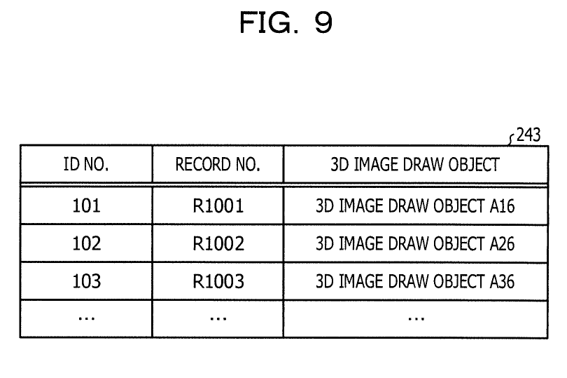

The panoramic image table 243 is a table holding information about plural three-dimensional image draw objects constituting the three-dimensional panoramic image. FIG. 9 is a diagram illustrating an example of the data structure of a panoramic image table. As illustrated in FIG. 9, the panoramic image table 243 includes identification numbers, record numbers, and three-dimensional image draw objects, which are associated with each other. The identification numbers are information uniquely identifying the respective three-dimensional image draw objects. The record numbers are numbers to associate the records in the panoramic image table 243 with the records in the management table 241. The three-dimensional image draw objects are information disposed to generate the three-dimensional panoramic image.

For example, a three-dimensional image draw object A16 is generated based on the record of record number R1001 in the management table 241. A three-dimensional image draw object A26 is generated based on the record of record number R1002 in the management table 241. A three-dimensional image draw object A36 is generated based on the record of record number R1003 in the management table 241. The other three-dimensional image draw objects (not illustrated herein) are similarly associated with the records in the management table 241.

The controller 250 includes an acquisition section 251, a specification section 252, a display controller 253, and an instruction information transmitter 254. The controller 250 corresponds to an integrated device such as an ASIC or an FPGA. The controller 250 corresponds to an electronic circuit such as a CPU or an MPU, for example.

The acquisition section 251 is a processing section configured to receive an image frame from the operator terminal 100. Each time that the acquisition section 251 receives an image frame, the acquisition section 251 stores the feature map information, position and orientation information, and image information included in the received image frame, in the management table 241 against each record number.

The specification section 252 is a processing section specifying the direction of sight of the instructor looking at the three-dimensional panoramic image. The specification section 252 outputs the information of the specified direction of sight to the display controller 253. The specification section 252 specifies the instructor's direction of sight by receiving an indication of the instructor's direction of sight from the input section 220, for example. The specification section 252 may specify the instructor's direction of sight by using another technique. For example, the instructor wears a head mounted display including an acceleration and angular velocity sensor and the like, and the specification section 252 may specify the movement of the instructor's head and the instructor's direction of sight based on information obtained from the acceleration and angular velocity sensor.

The display controller 253 is a processing section configured to select some particular sets of image information from plural sets of image information in the management table 241 based on the information about the direction of sight and cause the display device 230 to display the three-dimensional panoramic image composed of the selected particular sets of image information. Hereinafter, a concrete description is given of the process by the display controller 253 below.

The display controller 253 acquires the position and orientation information and image information associated by the record numbers from the management table 241. The display controller 253 calculates a viewing angle based on the position and orientation information, the image information, and the information about the instructor's direction of sight. In the following description, the image information acquired by the display controller 253 from the management table 241 is referred to as a key frame properly.

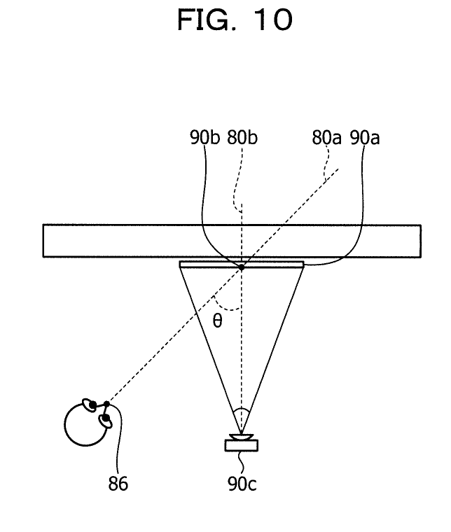

FIG. 10 is a diagram for explaining the process to calculate the viewing angle. In FIG. 10, the viewing angle θ is an viewing angle formed between a first line segment 80a and a second line segment 80b. The first line segment 80a is a straight line passing through an instructor's point 86 of sight and an image center 90b of a key frame 90a. The key frame 90a is disposed in a virtual space based on the feature map information.

The first line segment 80a is specified based on the information about the direction of sight and the image center 90b. The second line segment 80b is a straight line passing through the image center 90b and a position 90c of the camera 120. The position 90c is specified by the position and orientation information of the camera 120 at the time the camera 120 captures the key frame 90a. The second line segment 80b corresponds to a normal of the key frame 90a passing through the image center 90b.

The display controller 253 repeatedly executes the process to calculate the viewing angle for each key frame. The display controller 253 generates the list 242 by associating the record numbers corresponding to the key frames with the viewing angles and sorting the records by the viewing angles in ascending order. The initial value of the non-display flag corresponding to each record number is set to off.

Subsequently, the display controller 253 executes the following process to determine whether to set the non-display flag of the record number corresponding to each key frame to on or off and update the non-display flag. When the non-display flag is off, the key frame of interest is used to generate the three-dimensional panoramic image. On the other hand, when the non-display flag is on, the key frame of interest is not used to generate the three-dimensional panoramic image.

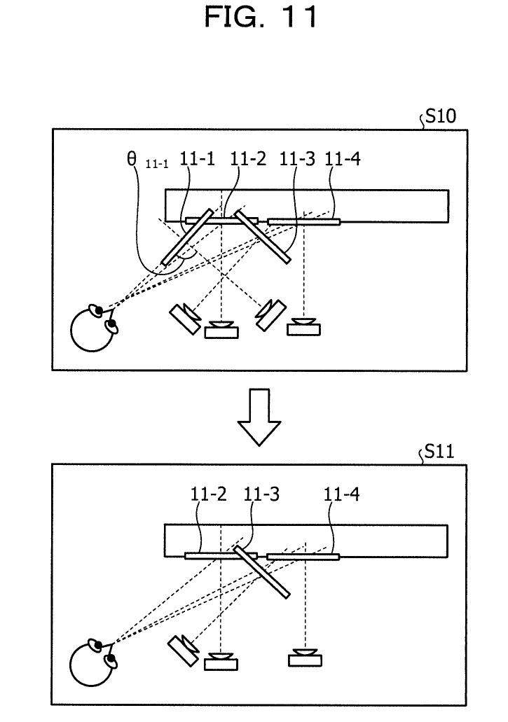

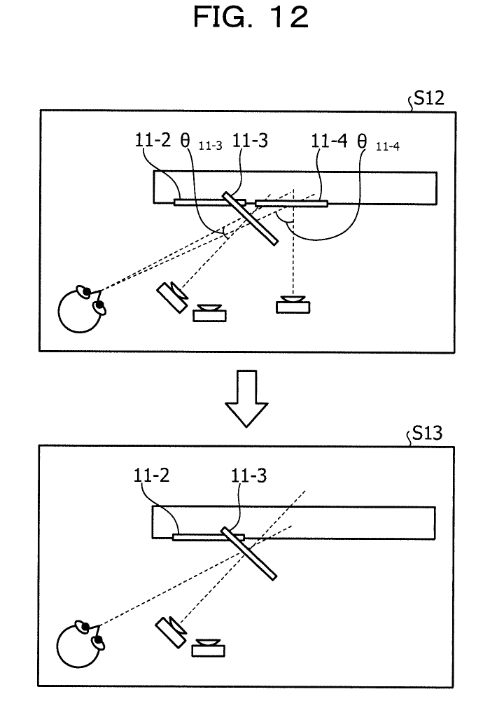

FIGS. 11 and 12 are diagrams for explaining the process by the display controller. First, the display controller 253 calculates the viewing angle for each key frame as described above. The display controller 253 then sets to on, the non-display flag corresponding to each key frame with a viewing angle of not less than a predetermined threshold value. The predetermined threshold value is 90 degrees herein.

A description is given of step S10 of FIG. 11. Herein, the description is given by using key frames 11-1, 11-2, 11-3, and 11-4 by way of example. It is assumed that the viewing angle θ11-1 of the key frame 11-1, among the key frames 11-1 to 11-4, is not less than the threshold value. In this case, the display controller 253 sets to on, the non-display flag corresponding to the record number of the key frame 11-1.

A description is given of step S11 of FIG. 12. When the display controller 253 sets to on, the non-display flag corresponding to the record number of the key frame 11-1 as described above, the key frame 11-1 is removed from the key frames constituting the three-dimensional panoramic image.

Subsequently, the display controller 253 selects key frames including similar image features from the key frames with the non-display flag set to off. When plural key frames include similar image features, the display controller 253 sets to off, the non-display flag of the key frame with the smallest viewing angle among the key frames including similar image features while setting the non-display flags of the other key frames to on.

A description is given of step S12 of FIG. 12. Herein, the viewing angles of the key frames 11-2 to 11-4 are smaller than the predetermined threshold by way of example. Moreover, it is assumed that the image features of the key frame 11-3 are similar to those of the key frame 11-4. The display controller 253 compares the viewing angle θ11-3 of the key frame 11-3 with the viewing angle θ11-4 of the key frame 11-4. The display controller 253 sets to off, the non-display flag of the key frame 11-3 with the smaller viewing angle while setting to on, the non-display flag of the key frame 11-4.

A description is given of step S13 of FIG. 12. When the display controller 253 sets to on, the non-display flag corresponding to the record number of the key frame 11-4, the key frame 11-4 is removed from the key frames constituting the three-dimensional panoramic image.

Herein, a description is given of an example of the process by the display controller 253 to determine the pair of key frames including similar image features. To acquire key frames using a SLAM technique, image feature extraction is performed for each pixel on each key frame using various image feature extraction methods including FAST, AGAST, ORB, BRISK, GFTT, AKAZE, and MSER. The display controller 253 compares the image features of two key frames and determines whether the image features are the same to specify feature points of the same image features.

The display controller 253 calculates SSO indicating the index of the similarity between images based on Expression 1.

SSO=number of common image feature points/(number of image feature points in a first key frame+number of image feature points in a second key frame−number of common image feature points) (1)

When the images of the first and second key frames are completely identical, for example, SSO is equal to 1. When the images of the first and second key frames are completely different, for example, SSO is equal to 0. The display controller 253 determines that the first and second key frames are a similar key frame pair when SSO is not less than a threshold value T.

The display controller 253 repeatedly executes the aforementioned process for each key frame with an viewing angle of smaller than the predetermined threshold value to determine the similar key frame pair.

Next, a description is given of a process by the display controller 253 to generate the three-dimensional panoramic image using the image information with the non-display flags set to off in the list 242. The image information with the non-display flags set to off is specified based on record numbers corresponding to the non-display flags set to off in the list 242. For example, the non-display flag of record number R1001 is off in FIG. 8. Accordingly, the image information of record number R1001 in FIG. 7 is used in generating the three-dimensional panoramic image.

The display controller 253 generates a frustum-shaped referential object and performs texture-mapping for the bottom of the referential object with the image information with the non-display flag set to off to generate a three-dimensional image draw object. The display controller 253 then stores the generated three-dimensional image draw object in the panoramic image table 243. It is assumed that the shape of the referential object is previously determined. The display controller 253 repeatedly executes the aforementioned process for all the sets of the image information with the non-display flags set to off.

The display controller 253 disposes the three-dimensional image draw objects stored in the panoramic image table 243 based on the position and orientation information to generate the three-dimensional panoramic image. The display controller 253 outputs the information about the generated three-dimensional panoramic image to the display device 230 and causes the display device 230 to display the three dimensional panoramic image.

The instruction information transmitter 254 is a processing section configured to transmit to the operator terminal 100, the instruction information inputted by the instructor through the input section 220 or the like.

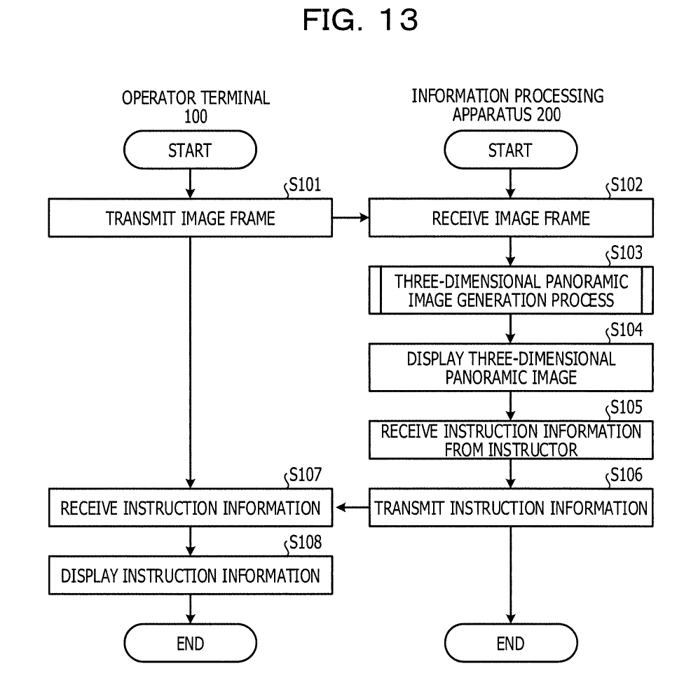

Next, a description is given of an example of the processing procedure of the system according to the embodiment. FIG. 13 is a flowchart illustrating an example of the processing procedure of the system according to the embodiment. As illustrated in FIG. 13, the operator terminal 100 transmits image frames to the information processing apparatus 200 (step S101). The information processing apparatus 200 receives the image frames from the operator terminal 100 (step S102).

The information processing apparatus 200 executes the three-dimensional panoramic image generating process (step S103). The information processing apparatus 200 displays a three-dimensional panoramic image (step S104). The information processing apparatus 200 accepts the instruction information from the instructor (step S105).

The information processing apparatus 200 transmits the instruction information to the operator terminal 100 (step S106). The operator terminal 100 receives the instruction information from the information processing apparatus 200 (step S107) and displays the received instruction information to the operator (step S108).

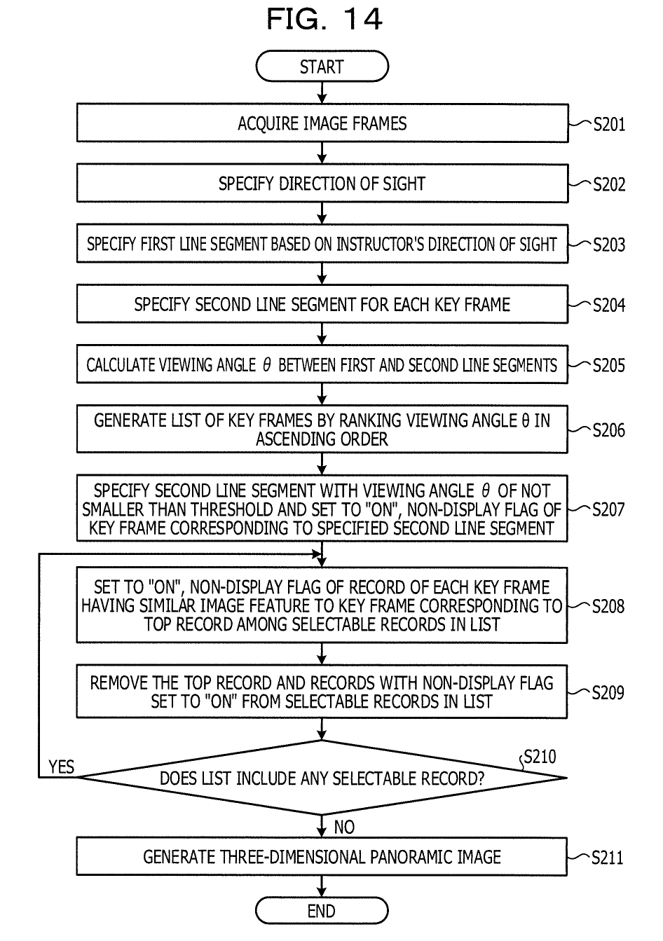

Next, a description is given of the processing procedure of the three-dimensional panoramic image generating process described at the step S103 in FIG. 13. FIG. 14 is a flowchart illustrating the processing procedure of the three-dimensional panoramic image generating process. As illustrated in FIG. 14, the acquisition section 251 of the information processing apparatus 200 acquires image frames from the operator terminal 100 (step S201).

The specification section 252 of the information processing apparatus 200 specifies the instructor's direction of sight (step S202). The display controller 253 of the information processing apparatus 200 specifies the first line segment based on the instructor's direction of sight (step S203). The display controller 253 specifies the second line segment for each key frame (step S204).

The display controller 253 calculates the viewing angle between the first and second line segments for each frame (step S205). The display controller 253 generates the list 242 by ranking the viewing angles in ascending order (step S206). The display controller 253 specifies the second line segment with a viewing angle θ of not smaller than the threshold value with respect to the first line segment and sets to on, the non-display flag of the key frame corresponding to the specified second line segment (step S207).

The display controller 253 sets to on, the non-display flag of the record of the key frame including similar image features to the key frame corresponding to the record at the top of the list 242 among selectable records in the list 242 (step S208). In the step S208, the key frame corresponding to the record at the top of the list 242 indicates image information corresponding to the record number at the top of the list 242. The key frame including similar image features indicates image information including the similar image features to the image information corresponding to the record number at the top of the list 242.

Among the selectable records in the list 242, the display controller 253 removes the record at the top and a record with the non-display flag set to on (step S209).

The display controller 253 determines whether the list 242 includes a selectable record (step S210). When the list 242 includes a selectable record (YES in step S210), the display controller 253 moves to the step S208.

On the other hand, when the list 242 does not include any selectable record (NO in step S210), the display controller 253 generates a three-dimensional panoramic image (step S211).

Next, a description is given of the effects of the information processing apparatus 200 according to the embodiment. To generate a three-dimensional panoramic image in accordance with positions where the camera 120 captures images, the information processing apparatus 200 deletes image information other than proper sets of image information from plural sets of similar image information based on the instructor's direction of sight to generate a three-dimensional panoramic image. Accordingly, the information processing apparatus 200 therefore generates a three-dimensional panoramic image that is easily visible to the instructor. When there are plural sets of similar image information, for example, the information processing apparatus 200 uses the sets of information on images facing the front of the user more based on the user's direction of sight, thus generating an easily visible three-dimensional panoramic image.

The information processing apparatus 200 executes the process to for each set of image information, specify the viewing angle formed between the first line segment based on the direction of sight and the center of the image and the second line segment passing through the position where the image is captured and the center of the image and selects an image with a viewing angle of smaller than the predetermined threshold as a particular image. Accordingly, it is possible to accurately select information of images facing the user.

The information processing apparatus 200 extracts plural similar images from the images with a viewing angle of smaller than the predetermined threshold value and from the extracted images, selects an image with the smallest viewing angle as a particular image. Accordingly, when plural similar images facing in different directions are densely arranged, the information processing apparatus 200 generates the three-dimensional panoramic image by using information of images facing the front of the user more, among the images densely arranged. Even when the operator on the work site checks an object by looking at the object from various directions, the three-dimensional panoramic image generated by the image processing apparatus 200 is easily visible to the instructor.

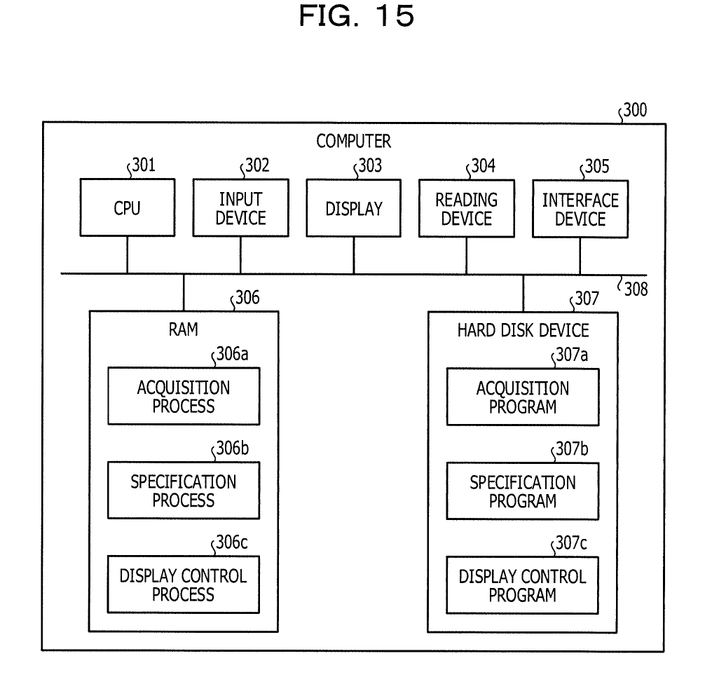

Next, a description is given of an example of the hardware configuration of a computer implementing the same functions as those of the information processing apparatus 200 described in the above embodiment. FIG. 15 is a diagram illustrating an example of the hardware configuration of the computer implementing the same functions as those of the information processing apparatus.

As illustrated in FIG. 15, a computer 300 includes a CPU 301 executing various operational processes, an input device 302 accepting an input of data from the user, and a display 303. The computer 300 further includes a reading device 304 configured to read programs and the like from a storage medium and an interface device 305 exchanging data with another computer through a network. The computer 300 includes a RAM 306 temporarily storing various types of information and a hard disk device 307. The devices 301 to 307 are connected to a bus 308.

The hard disk device 307 includes an acquisition program 307a, a specification program 307b, a display control program 307c. The CPU 301 loads the acquisition program 307a, specification program 307b, and display control program 307c on the RAM 306.

The acquisition program 307a functions as an acquisition process 306a. The specification program 307b functions as a specification process 306b. The display control program 307c functions as a display control process 306c.

The acquisition process 306a corresponds to the process of the acquisition section 251. The specification process 306b corresponds to the process of the specification section 252. The display control process 306c corresponds to the display controller 253.

The programs 307a to 307c do not have to be stored in the hard disk device 307 from the beginning. For example, each of the programs 307a to 307c may be stored in a portable physical medium inserted into the computer 300, such as a flexible disk (FD), a CD-ROM, a DVD disk, a magneto optical disk, and an IC card, for example. The computer 300 reads and executes the programs 307a to 307c.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. An information processing apparatus comprising:
a memory; and
a processor coupled to the memory and configured to
execute an acquisition process that includes acquiring a plurality of images which are captured from different positions and include a same feature point,
execute a specification process that includes specifying the direction of sight of a user who looks at a panoramic image which is generated based on the plurality of images, and
execute a display control process that includes selecting particular images from the plural images based on the direction of sight and displaying the panoramic image composed of the selected particular images.

2. The information processing apparatus according to claim 1,
wherein the display control process includes executing a process to specify an viewing angle for each image and selecting the particular images based on the specified viewing angles, the viewing angle being an angle formed between a first line segment based on the direction of sight and the center of the image and a second line segment passing through the position where the image is captured and the center of the image.

3. The information processing apparatus according to claim 2,
wherein the display control process includes selecting an image with a viewing angle of smaller than a predetermined value, as one of the particular images.

4. The information processing apparatus according to claim 3,
wherein the display control process includes extracting a plurality of similar images from the images with a viewing angle of smaller than the predetermined threshold value and selecting as one of the particular images, an image with the smallest viewing angle among the extracted images.

5. A method for panoramic image display, performed by a computer, the method comprising:
executing, by a processor of the computer, an acquisition process that includes acquiring a plurality of images which are captured from different positions and include a same feature point,
executing, by the processor of the computer, a specification process that includes specifying the direction of sight of a user who looks at a panoramic image which is generated based on the plurality of images, and
executing, by the processor of the computer, a display control process that includes selecting particular images from the plural images based on the direction of sight and displaying the panoramic image composed of the selected particular images.

6. The method according to claim 5,
wherein the display control process includes executing a process to specify an viewing angle for each image and selecting the particular images based on the specified viewing angles, the viewing angle being an angle formed between a first line segment based on the direction of sight and the center of the image and a second line segment passing through the position where the image is captured and the center of the image.

7. The method according to claim 6,
wherein the display control process includes selecting an image with a viewing angle of smaller than a predetermined value, as one of the particular images.

8. The method according to claim 7,
wherein the display control process includes extracting a plurality of similar images from the images with a viewing angle of smaller than the predetermined threshold value and selecting as one of the particular images, an image with the smallest viewing angle among the extracted images.

9. A non-transitory computer-readable storage medium for storing a data transfer program that causes a computer to execute a process, the process comprising:
executing an acquisition process that includes acquiring a plurality of images which are captured from different positions and include a same feature point,
executing a specification process that includes specifying the direction of sight of a user who looks at a panoramic image which is generated based on the plurality of images, and
executing a display control process that includes selecting particular images from the plural images based on the direction of sight and displaying the panoramic image composed of the selected particular images.

10. The non-transitory computer-readable storage medium according to claim 9,
wherein the display control process includes executing a process to specify an viewing angle for each image and selecting the particular images based on the specified viewing angles, the viewing angle being an angle formed between a first line segment based on the direction of sight and the center of the image and a second line segment passing through the position where the image is captured and the center of the image.

11. The non-transitory computer-readable storage medium according to claim 10,
wherein the display control process includes selecting an image with a viewing angle of smaller than a predetermined value, as one of the particular images.

12. The non-transitory computer-readable storage medium according to claim 11,
wherein the display control process includes extracting a plurality of similar images from the images with a viewing angle of smaller than the predetermined threshold value and selecting as one of the particular images, an image with the smallest viewing angle among the extracted images.
